(19) United States
(12) Patent Application Publication
(10) Pub. No.: US 2025/0123363 A1
(43) Pub. Date: Apr. 17, 2025

(54) CAMERA MODULE

(71) Applicant: LG INNOTEK CO., LTD., Seoul (KR)

(72) Inventors: Min Woo LEE, Seoul (KR); Sun Min HWANG, Seoul (KR)

(21) Appl. No.: 18/688,048

(22) PCT Filed: Sep. 1, 2022
(86) PCT No.: PCT/KR2022/013094

§ 371 Date: Feb. 29, 2024

(30) Foreign Application Priority Data
Sep. 2, 2021 (KR) 10-2021-0117265

(51) Int. Cl. G01S 7/481

(52) U.S. Cl. CPC G01S 7/4813

(57) ABSTRACT

A camera module according to an embodiment of the present invention comprises: a lens barrel which accommodates a lens; a sensor which receives light passed through the lens; a first substrate having the sensor arranged on a first surface thereof; a second substrate which is apart from the first substrate and has at least one light source device arranged thereon; a first body which includes a lens barrel accommodating portion including a first hole in which the lens barrel is accommodated, and a second hole formed in the light-emitting direction of the light source device; and a second body coupled to the first body, wherein the first substrate and the second substrate are arranged in the inner space formed by the first body and the second body, and the sensor includes a ToF sensor.

### DESCRIPTION OF INVENTION

### Technical Field

The present invention relates to a camera module, and more specifically, to a camera module in which a TOF sensor and a light source are disposed on different substrates.

### Background Art

Research on devices capable of acquiring depth images that can obtain distance information to an object has recently been on the rise.

Following this trend, a time-of-flight (TOF) module has been introduced as a depth image acquisition device. The TOF module acquires depth images by irradiating light to an object and then measuring the flight time of a light in which the light being reflected from the object is received by a light receiving unit.

As shown in FIG. 1, light emitted from a VCSEL, a light source element, is emitted from an object and generates a depth image in a sensor that receives the light through a lens.

However, the accuracy of the depth image varies depending on the distance between the VCSEL, which is the light emitting unit, and the lens and sensor, which are the light receiving unit. If the VCSEL and the TOF sensor are close together, accuracy increases, but if the distance is too close, there is a problem in that the lens becomes caught in the VCSEL's light emission angle of view. When a TOF sensor and a VCSEL are formed on the same substrate, module size and performance are affected for the above reasons. In addition, there is also a problem that the heat generated by the VCSEL may affect the sensor.

### DETAILED DESCRIPTION OF THE INVENTION

### Technical Subject

The technical problem to be solved by the present invention is to provide a camera module in which a TOF sensor and a light source are disposed in different substrates.

### Technical Solution

In order to solve the above technical challenges, a camera module according to an embodiment of the present invention comprises: a lens barrel which accommodates a lens; a sensor which receives light passed through the lens; a first substrate having the sensor being disposed on a first surface thereof; a second substrate which is apart from the first substrate and has at least one light source device being disposed thereon; a first body which includes a lens barrel accommodating portion including a first hole in which the lens barrel is accommodated, and a second hole being formed in a light-emitting direction of the light source device; and a second body being coupled to the first body, wherein the first substrate and the second substrate are disposed in the inner space being formed by the first body and the second body, and wherein the sensor includes a ToF sensor.

In addition, it may include a flexible substrate connecting the first substrate and the second substrate.

In addition, the first body includes: a first region being formed with the lens barrel accommodating portion; a second region being spaced apart from the first region in an optical axis direction and being formed with the second hole; an upper plate including a third region connecting the first region and the second region; and a side plate being extended from the upper plate, wherein the first region and the second region of the upper plate may form a step.

In addition, the lens barrel accommodating portion may be formed by being extended from the first region and the third region.

In addition, when the lens barrel is accommodated in a lens barrel accommodating portion, it may include a recessed portion being formed in the second region and the third region in a position corresponding to the lens barrel and corresponding to the shape of the lens barrel.

In addition, the cross-section of the second hole is in the shape of a cube; the second hole is inclinedly formed so that the cross-sectional region is expanded in a light emission direction of the light source element; and the surface adjacent to the recessed portion among the four inclined surfaces of the second hole may include ribs being formed according to the shape of the recessed portion.

In addition, the second body includes: a base; and a side plate being extended vertically from the base, wherein a side plate of the second body may comprise: a body portion being extended vertically from the base; a first extension portion being extended from the body portion; and a second extension portion adjacent to the first extension portion and being extended from the side plate of the second body and formed with a coupling hole.

In addition, the side plate of the first body may include: a first accommodating portion in which the first extension portion is accommodated at a position corresponding to the first extension portion; and a second accommodating portion being accommodated with the second extension portion in a position corresponding to the second extension portion and includes a protrusion being coupled to a coupling hole of the second extension portion.

In addition, the side plate of the second body may include: a first side plate including one first extension portion and two second extension portions being formed on both sides of the first extension portion; and a second side plate including one second extension portion and two first extension portions being formed on both sides of the second extension portion.

In addition, the cross-sectional region of the second hole corresponds to the cross-sectional region of the light source element, and may be formed to be inclined so as to widen the cross-sectional area in a light emission direction.

In addition, the inclined angle of the second hole may correspond to the light emission angle of the light source element.

In addition, the second body may include a heat sink.

In addition, the first body and the second body may include a third hole through which a connector being connected to the outside in a direction perpendicular to the optical axis or power connector where power source is connected passes through.

### Advantageous Effects

According to embodiments of the present invention, the sensor and the light source element can be disposed close to each other, thereby improving the accuracy of the TOF camera module. Additionally, by forming the sensor and the light source element on different substrates, the heat generation and expansion of the sensor due to heat generation from the light source element can be minimized, thereby improving high temperature resolution. In addition, by forming a step in the front body, it is possible to solve the problem of the angle of view of the light source element being blocked and minimize the size of the device. Furthermore, even though the sensor and the light source element are formed on different substrates, the gap between the sensor and the light source element can be firmly maintained, thereby maintaining the reliability of the TOF camera module.

### BRIEF DESCRIPTION OF DRAWINGS

FIG. 1 is a diagram for explaining a comparative example of a camera module according to an embodiment of the present invention.

FIG. 2 is a perspective view of a camera module according to an embodiment of the present invention.

FIG. 3 is an exploded perspective view of a camera module according to an embodiment of the present invention.

FIG. 4 is a perspective view of a first body of a camera module according to an embodiment of the present invention.

FIG. 5 is a top view of a first body of a camera module according to an embodiment of the present invention.

FIG. 6 is a cross-sectional view of a camera module according to an embodiment of the present invention.

FIG. 7 is a perspective view of a first substrate of a camera module according to an embodiment of the present invention.

FIG. 8 is a perspective view of a first to third substrates of a camera module according to an embodiment of the present invention combined.

FIG. 9 is a side view of a first to third substrates of a camera module according to an embodiment of the present invention combined.

FIG. 10 is a perspective view of a second body of a camera module according to an embodiment of the present invention.

FIG. 11 is a perspective view viewed from a lower portion of a second body of a camera module according to an embodiment of the present invention.

FIG. 12 is a perspective view of a second extension portion of a camera module according to an embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or arranged in “on (above)” or “below (under)” of each component, “on (above)” or “below (under)” means that it includes not only the case where the two components are directly in contact with, but also the case where one or more other components are formed or arranged between the two components. In addition, when expressed as “on (above)” or “below (under)”, the meaning of not only an upward direction but also a downward direction based on one component may be included.

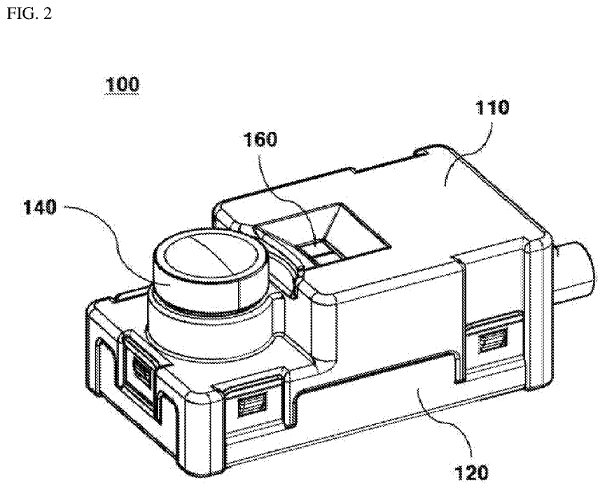

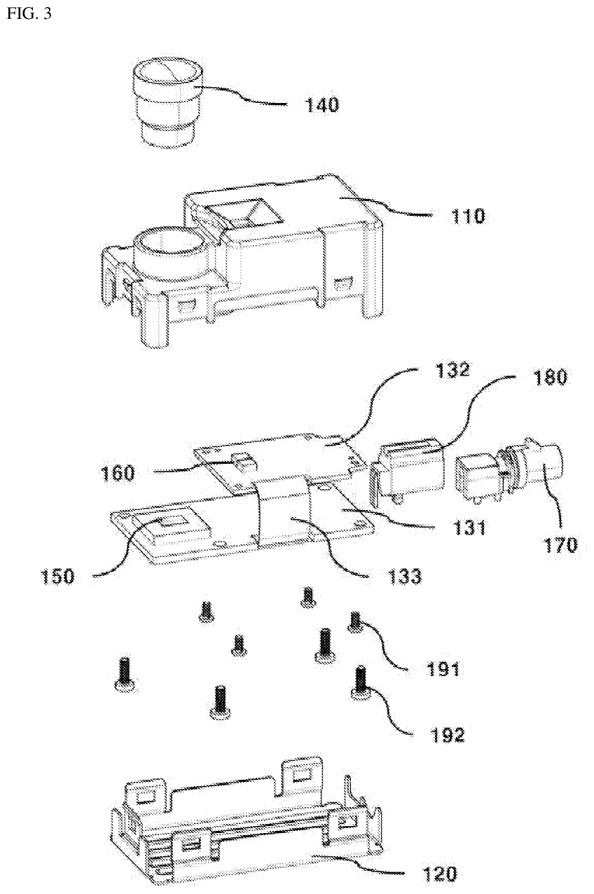

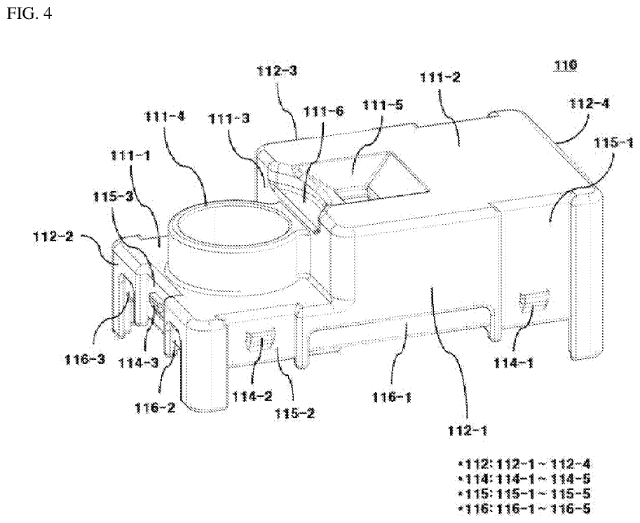

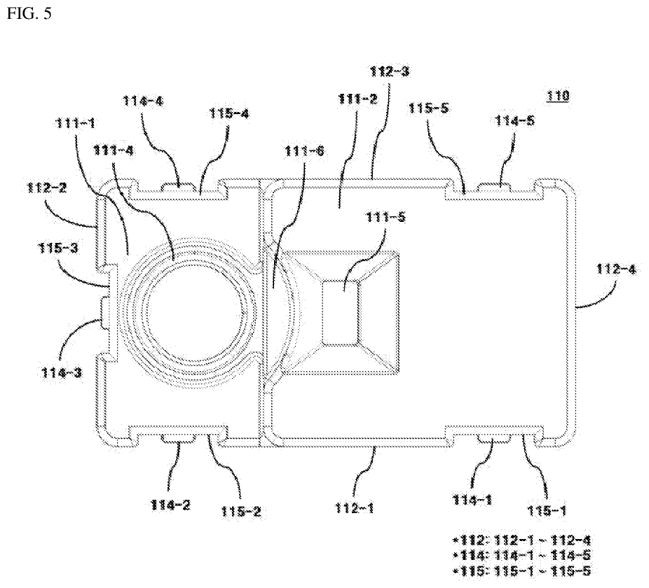

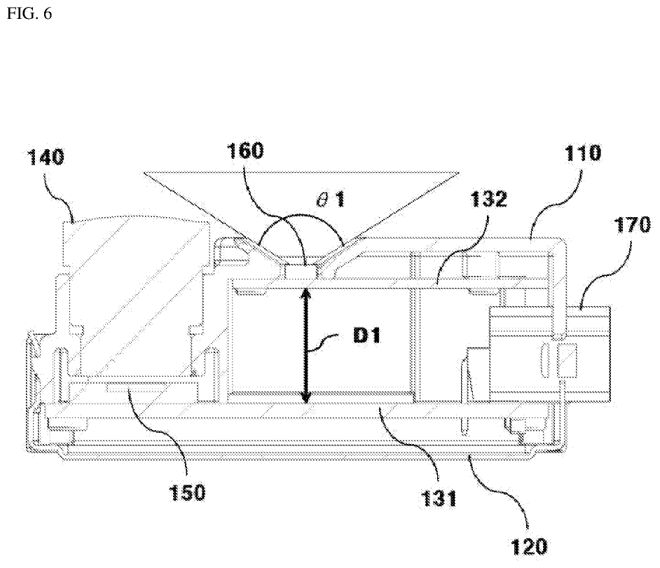

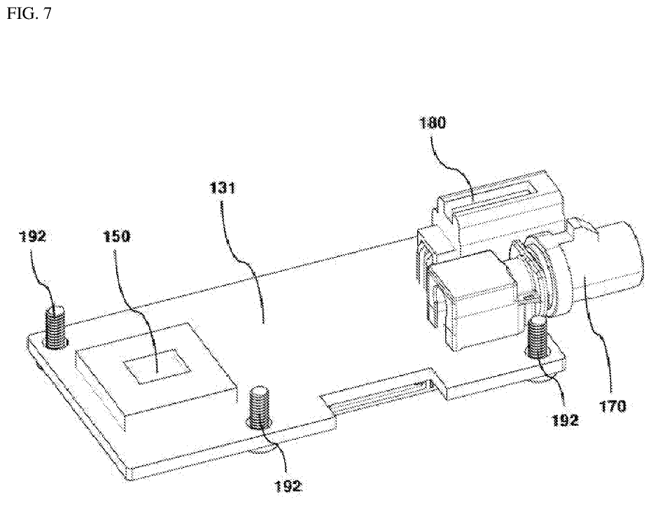

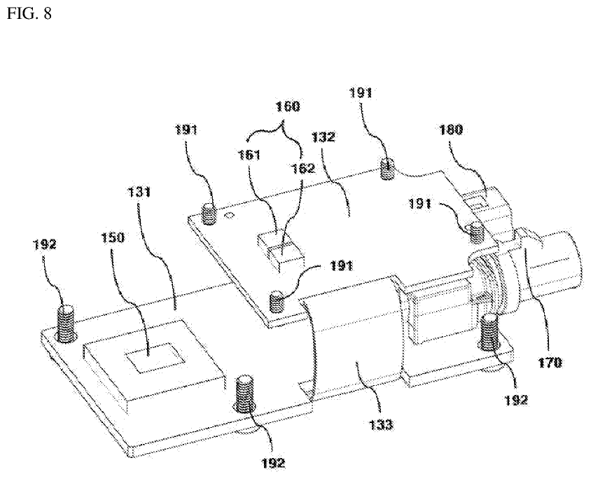

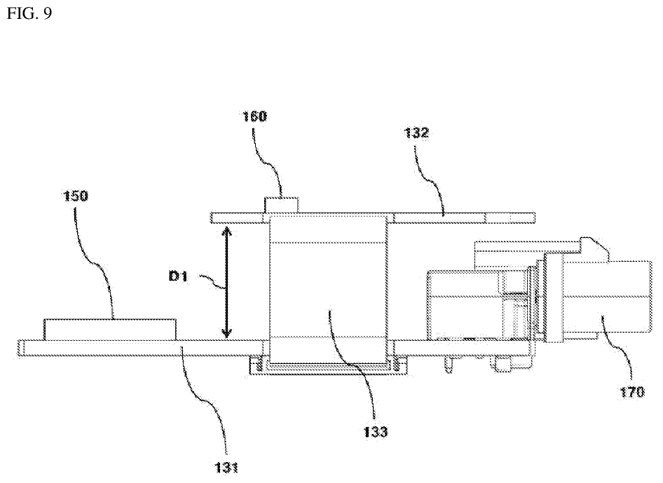

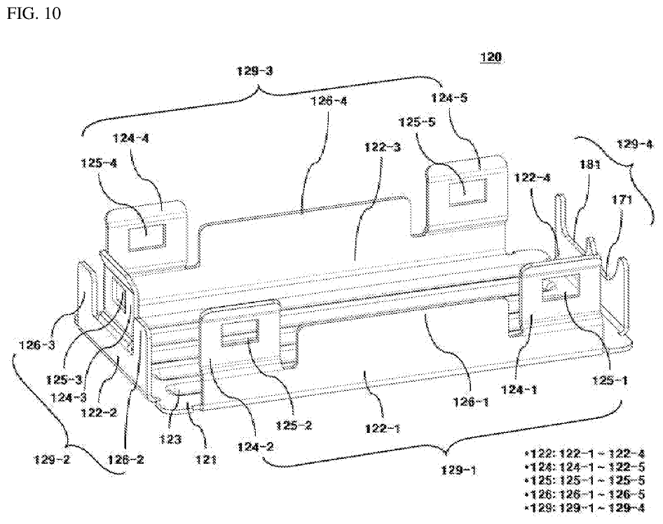

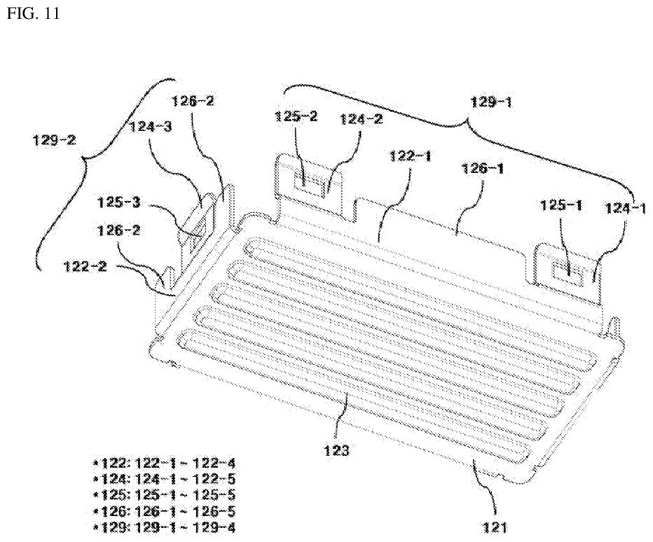

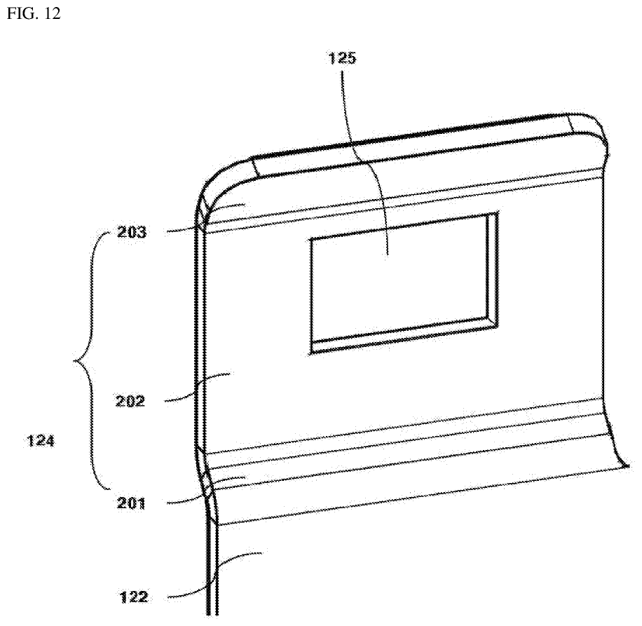

FIG. 2 is a perspective view of a camera module according to an embodiment of the present invention; FIG. 3 is an exploded perspective view of a camera module according to an embodiment of the present invention; FIG. 4 is a perspective view of a first body of a camera module according to an embodiment of the present invention; FIG. 5 is a top view of a first body of a camera module according to an embodiment of the present invention; FIG. 6 is a cross-sectional view of a camera module according to an embodiment of the present invention; FIG. 7 is a perspective view of a first substrate of a camera module according to an embodiment of the present invention; FIG. 8 is a perspective view of a first to third substrates of a camera module according to an embodiment of the present invention combined; FIG. 9 is a side view of a first to third substrates of a camera module according to an embodiment of the present invention combined; FIG. 10 is a perspective view of a second body of a camera module according to an embodiment of the present invention; FIG. 11 is a perspective view viewed from a lower portion of a second body of a camera module according to an embodiment of the present invention; and FIG. 12 is a perspective view of a second extension portion of a camera module according to an embodiment of the present invention.

The camera module 100 according to an embodiment of the present invention comprises a body, a plurality of substrates, a lens, a sensor, and a light source element.

The lens barrel 140 accommodates a lens. The lens may include one or more lenses and may be accommodated in the lens barrel 140 and the lens barrel accommodating portion 111-4 of the first body 110. The lens may include a plurality of lenses considering lens imaging, aberration correction, or zoom functions. A plurality of lenses may be repeatedly disposed and assembled to form a micro lens array (MLA).

The sensor 150 receives light passing through the lens. Here, the sensor 150 includes a TOF sensor. The TOF sensor is a sensor that measures flight time. When light is emitted from the light source element 160, reflected from the object, and received, it creates a depth image using the time from being emitted from the light source element to being received. Depending on the distance measurement method, TOF sensors include indirect TOF sensors I-TOF that use phase differences and direct TOF sensors D-TOF that directly measure time differences. Direct TOF sensors are also referred to as LIDAR sensors. The sensor 150 may be an image sensor and may include an RGB sensor.

The light source element 160 emits light. The light being emitted from the light source element may be infrared or near-infrared. The light source element 160 may be a light emitting diode (LED), a laser diode (LD), or a super luminescent diode (SLD). The light source element 160 may be configured to further include other optical members for irradiating frequency-modulated light to an object, controlling the path of the irradiated light, or forming a pattern. The light source element 160 may include a plurality of light source elements 161 and 162. The plurality of light source elements 161 and 162 may be disposed in an array form.

The light source element 160 may include a VCSEL. VCSEL is a vertical cavity surface light-emitting laser that converts electrical signals into optical signals and emits lasers in a direction perpendicular to the upper surface that emits light.

The sensor 150 generates a depth image by measuring the distance to the object using light emitted from the light source element 160, reflected from the object, and received through the lens; and a 3D image can be generated using the RGB image and depth image being generated from the image sensor.

The sensor 150 is disposed on the first substrate 131, and the light source element 160 is disposed on the second substrate 132. Here, the first substrate 131 and the second substrate 132 are arranged to be spaced apart from each other in an internal space formed by the first body 110 and the second body 120. Because the sensor 150 and the light source element 160 are formed in different substrates, their influence on each other can be reduced. When the light source element 160 converts an electrical signal into an optical signal and emits light, heat is generated. The sensor 150 is an image sensor that generates a lot of heat, and its performance may deteriorate due to heat. By forming the sensor 150 and the light source element 160 in different substrates, heat being generated from the light source element 160 can be prevented from affecting the sensor 150.

The first substrate 131 and the second substrate 132 may be connected through a flexible substrate. The first substrate 131 and the second substrate 132 may be a rigid substrate or may be connected through a flexible substrate. In order to receive a control signal from a control unit (not shown) or transmit a control signal, the first substrate 131 and the second substrate 132 may be connected to each other. The control unit is disposed on the first to second substrates 131 and 132 and can transmit a control signal to another substrate in which the control unit is not disposed through the third substrate 133, which is a flexible substrate. When receiving a control signal from an externally located control unit, one of the first substrate 131 or the second substrate 132 is connected to the connector 170 being connected to the outside, and other substrates can receive control signals from a substrate being connected to the outside.

The first substrate 131 and the second substrate 132 may be connected to the third substrate 133, which is a flexible substrate, through a connector, or may be directly connected inside the substrate. A rib is formed inside the portion where the third substrate 133 is connected to form a space in which the third substrate 133 can be bent. The first substrate 131 and the second substrate 132 may be connected using a rigid substrate in addition to a flexible substrate, may be connected in various other ways, or may be connected to each connector instead of being connected to each other.

The first body 110 includes: a lens barrel accommodating portion 111-4 including a first hole in which the lens barrel 140 is accommodated; and a second hole 111-5 being formed in a light emission direction of the light source element 160. The first body 110 is a body located in a direction in which light is emitted from the light source element 160 and the lens receives the light, and may be referred to as a front body or an upper body. The lens barrel accommodating portion 111-4 is formed to correspond to the shape of the lens barrel 140 so that the lens barrel 140 can be accommodated, and the first hole is formed so that the sensor 150 being disposed on the first substrate 131 can receive the light that has passed through the lens being accommodated in the lens barrel 140. The lens barrel accommodating portion 111-4 may include a bracket portion being protruded upward to accommodate the lens barrel 140. In addition, the first body 110 includes a second hole 111-5 so that light emitted from the light source device 160 being disposed on the second substrate 132 is emitted to the outside.

The first body 110 is configured with an upper plate and a side plate 112.

The upper plate of the first body 110 comprises: a first region 111-1 where the lens barrel accommodating portion 111-4 is formed; a second region 111-2 being spaced apart from the first region 111-1 in an optical axis direction to form a second hole 111-5; a third region 111-3 connecting the first region 111-1 and the second region 111-2. The first body 110 may include a side plate 112 being extended downward from the upper plate. The side plate 112 of the first body 110 not only forms an internal space where the substrate is disposed, but also serves to be coupled to the second body 120.

A lens barrel accommodating portion 111-4 is formed on the first region 111-1 of the upper plate of the first body 110. The first region 111-1 may include a first surface perpendicular to the optical axis and a lens barrel accommodating portion 111-4 being extended from the first surface to accommodate the lens barrel. As shown in FIG. 4, the lens barrel accommodating portion 111-4 is formed in a circular shape corresponding to the shape of the lens barrel 140 to be protruded, and a first hole capable of accommodating the lens barrel 140 may be formed inside.

A second hole 111-5 is formed on the second region 111-2 of the upper plate of the first body 110 at a position where light is emitted from the light source element 160. The second hole 111-5 is a hole through which light is emitted from the light source element 160, and the cross-sectional area of the second hole 111-5 corresponds to the cross-sectional area of the light source element 160, and may be formed to be inclined to widen the cross-sectional area in a direction of light emission. The light source element 160 may be square or circular depending on the shape of the light source. The cross-sectional area of the second hole 111-5 may be formed to correspond to the cross-sectional area of the light source element 160. The light source element 160 that emits surface light may have a square cross-section, and the cross-section of the second hole 111-5 may also have a square cross-section. Because light is emitted and spreads with a certain angle of view, which is the angle of light emission, in order not to impede the propagation of light, the cross-sectional area of the second hole 111-5 may be inclined to widen in a direction of light emission. When the cross-sectional area of the second hole 111-5 is square, the second hole 111-5 includes four inclined surfaces, and the inclined surfaces may be formed in a trapezoid. Here, the inclined angle of the second hole 111-5 may correspond to the light emission angle of the light source element 160. As shown in FIG. 6, the inclined angle of the second hole 111-5 may be formed to correspond to the angle of view θ1, which is the light emission angle of the light source element 160. Through this, the progress of the emitted light may not be interrupted. Or, in order to increase the directivity of light, the light emission angle may be formed using the degree of inclination. When the angle of view of the light source element 160 is greater than the target light emission angle, the angle of the inclined plane may be formed as the light emission angle so that the emitted light is emitted at the light emission angle.

The second hole 111-5 may include a cover to protect the light source element 160. The cover is formed as a transparent window to protect the light source element 160 and may not interfere with light emission.

The second region 111-2 of the upper plate of the first body 110 is formed to be spaced apart from the first region 111-1 in an optical axis direction, and includes a second surface being spaced apart from the first region 111-1 in an optical axis direction. The first region 111-1 and the second region 111-2 may be spaced apart by D1. The first region 111-1 and the second region 111-2 may be spaced apart from each other to form a step. At this time, the first region 111-1 and the second region 111-2 may be connected to each other through the third region 111-3. At this time, the first region 111-1 and the second region 111-2 are upper plates of different heights, and the third region 111-3 can be referred to as a side plate being extended from one upper plate to another upper plate to connect the two upper plates. The length of the third region 111-3 extended in an optical axis direction may be D1.

The lens barrel accommodating portion 111-4 may be formed to be extended from the first region 111-1 and the third region 111-3. That is, the lens barrel accommodating portion 111-4 is formed by being extended in an optical axis direction from the first region 111-1, but a portion of the side surfaces of the lens barrel accommodating portion 111-4 may be connected to the third region 111-3. The lens barrel accommodating portion 111-4 formed by being extended to the first region 111-1 and the third region 111-3 perpendicular to the first region 111-1 and is fixed in both directions perpendicular to each other so that the lens barrel 140 can be firmly fixed to the camera module 100.

The lens barrel 140 is located on the first region 111-1, and the light source element 160 is located on the second region 111-2. At this time, the second substrate 132 in which the light source element 160 is disposed is spaced apart from the first substrate 131 in an optical axis direction. As shown in FIG. 6, the first substrate 131 and the second substrate 132 are spaced apart from each other at a preset distance D1. The second substrate 132 is fixed to the second region 111-2 of the first body 110 so that the light source element 160 being disposed on the second substrate 132 can be located in the second hole 111-5. Therefore, in order for the second substrate 132 to maintain a distance of more than D1 from the first substrate 131, the second region 111-2 of the first body 110 must also maintain a sufficient distance from the first substrate 131. To this end, the second region 111-2 may be formed to be spaced apart from the first region 111-1 in an optical axis direction.

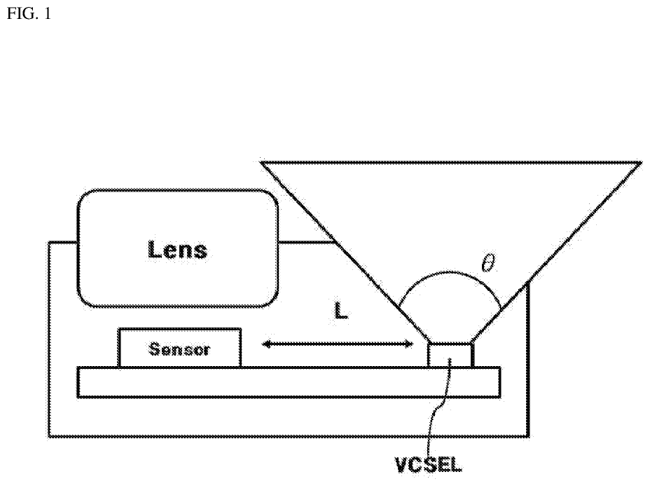

By separating the second substrate 132 from the first substrate 131 in an optical axis direction, the distance between the light source element 160 and the sensor 150 in a direction perpendicular to the optical axis can be reduced. The light emitted from the light source element 160 is directly emitted to the lens and is directly received by the lens, or when the light received by the lens is interrupted, an error may occur in generating a depth image. Therefore, there must be sufficient separation between the lens and the light source element 160 so that the lens is not located at the light emission angle. As shown in FIG. 1, when the sensor and the VCSEL, a light source element, are formed on the same substrate, the sensor must be separated from the VCSEL by more than a length L so that the light does not affect the lens. In contrast, the second substrate 132 is spaced apart from the first substrate 131 by D1, because the area of influence narrows depending on the angle of view at the same height, the light source element 160 can be disposed close to the sensor 150 in a direction perpendicular to the optical axis direction, as shown in FIG. 6. In other words, it is possible to miniaturize the module without interference from light.

When the lens barrel 140 is accommodated in the lens barrel accommodating portion 111-4, a recessed portion 111-6 being formed on the second region 111-2 and the third region 111-3 corresponding to the shape of the lens barrel 140 may be included at a position corresponding to the lens barrel 140. A portion of the lens barrel 140 may be disposed in the recessed portion 111-6. However, even in this case, the lens barrel 140 is not overlapped with the beam angle of the light source element 160, that is, the optical path.

When the sensor 150 and the light source element 160 are disposed close to each other, because the position of the lens barrel 140 coincides with the sensor 150 in an optical axis direction, the distance between the lens barrel 140 and the light source element 160 to the second hole 111-5 also becomes closer. The lens barrel 140 is accommodated in the lens barrel accommodating portion 111-4 formed on the first region 111-1, and as the lens barrel 140 and the light source element 160 are disposed close to each other, the area where the lens barrel accommodating portion 111-4 and the second hole 111-5 are formed become closer. As a result, there is interference between the lens barrel 140 and the second region 111-2 of the first body 110, or according to space constraints due to interference between the lens barrel 140 and the second region 111-2 of the first body 110 it may be difficult to dispose the light source element 160 and the sensor 150 close to each other. In addition, the process of coupling the lens barrel 140 to the lens barrel accommodating portion 111-4 may be difficult due to the narrow space at the corresponding location.

The recessed portion 111-6 is located at a position corresponding to the lens barrel 140, the first body 110, that is, in order to avoid interference at the location where the second region 111-2 and the third region 111-3 of the first body 110 meet, it is formed to correspond to the shape of the lens barrel 140. That is, depending on the cylindrical shape of the lens barrel, it can be formed in a cylindrical shape so as to enter inside, as shown in FIG. 4. Owing to the shape of the recessed portion 111-6, since interference with the lens barrel 140 can be reduced, the sensor 150 and the light source element 160 can be disposed closer together. In addition, the recessed portion 111-6 may be formed in a way that the surface of the recessed portion 111-6 is not to be in contact with the lens barrel 140 and is spaced apart at a predetermined interval to secure work space. Through this, the process of placing the lens barrel 140 in the lens barrel accommodating portion 111-4 can also be smoothly performed.

Depending on the shape of the recessed portion 111-6, the recessed portion 111-6 may partially be overlapped with the second hole 111-5. At this time, the cross-section of the second hole 111-5 is square, and the second hole 111-5 is inclinedly formed so as to widen the cross-sectional area in a light emission direction of the light source element 160, wherein among the four inclined surfaces of the second hole 111-5, the surface adjacent to the recessed portion 111-6 may include ribs being formed according to the shape of the recessed portion 111-6. As shown in FIGS. 4 and 5, when the second hole 111-5 has a square cross-section, the surface being overlapped with the recessed portion 111-6 may be formed with a rib having partially concave portion according to the shape of the recessed portion 111-6. Through the recessed portion 111-6 and the rib of the second hole 111-5, the sensor 150 and the light source element 160 can be disposed as close as possible without interference between the lens and the emitted light or between the lens barrel 140 and the first body 110.

Not only the light source element 160, but also other components necessary for the camera module can be disposed on the second substrate 132. In a surface opposite to the surface where the light source element 160 is disposed, a space is formed due to the gap up to the first substrate 131, so more components or components having larger heights can be disposed. This is advantageous for miniaturizing the module.

As shown in FIG. 7, the sensor 150 is disposed on the first surface of the first substrate 131 at a position that coincides with an optical axis of the lens. The first substrate 131 may be coupled to the second body 120 through the second coupling member 192 and fixed to the second body 120. A connector 170 being connected to the outside may be connected to the first substrate 131. Data can be transmitted to and received from the outside through the connector 170. Depth images or RGB images can be transmitted externally, or control signals can be received from the control unit. In addition, a power connector 180 being connected to a power source may be connected. The connector 170 and the power connector 180 may be connected in a direction perpendicular to the optical axis. By separating the first substrate 131 and the second substrate 132 in an optical axis direction, since the module size increases in the optical axis direction, connection to the outside or power source can be made in a direction perpendicular to the optical axis, thereby preventing the size increase in an optical direction and increasing the degree of freedom in design can be increased.

As shown in FIGS. 8 and 9, the first substrate 131 may be connected to the second substrate 132 and the third substrate 133, which is a flexible substrate. The second substrate 132 may be coupled to the second region 111-2 of the first body 110 through the first coupling member 191 and fixed to the first body 110, and the first substrate 131 may be coupled to the first region 111-1 of the first body 1110 through the second coupling member 192 and fixed to the first body 110. On the first region 111-1 and the second region 111-2 of the first body 110, coupling portions that can accommodate the second coupling member 192 and the first coupling member 191 to couple thereto may be respectively formed in a direction toward the substrate. The first coupling member 191 and the second coupling member 192 may be screw-coupling members such as bolts. It is natural that various other coupling members can be used.

The first substrate 131 and the second substrate 132 are coupled and fixed to the first region 111-1 and the second region 111-2 of the first body 110, which are spaced apart from each other in an optical axis direction. The first substrate 131 and the second substrate 132 are spaced apart by a gap D1, and through the gap D1, the sensor 150 and the light source element 160 can be disposed close to each other. As described above, the first region 111-1 and the second region 111-2 of the first body 110 may be formed to be spaced apart from each other by D1, and according to the spacing between the first region 111-1 and the second region 111-2, the first substrate 131 and the second substrate 132 may also be disposed to be spaced apart by D1. The first substrate 131 and the second substrate 132 are respectively fixed to the first region 111-1 and the second region 111-2 of the first body 110, which is integrally formed so that the gap between the first substrate 131 and the second substrate 132 can be firmly fixed.

The second body 120 may include a heat sink 123. The sensor 150 may be an image sensor, and is an element that generates a lot of heat and may be deteriorated due to heat, so heat dissipation is required. The second body 120 is coupled to the first substrate 131 in which the sensor 150 is disposed, and may perform a heat dissipation function by dissipating heat generated by the sensor 150 to the outside. To this end, a heat sink 123 may be included. The heat sink serves to discharge heat to the outside, and the second body 120 may include a heat dissipation pipe, as shown in FIGS. 10 and 11. A heat dissipation pipe is a heat pipe that contains a working fluid in a hollow cylinder and discharges heat to the outside through the working fluid. Or, it may include various heat sinks such as heat dissipation plats. The heat sink 132 of the second body 120 may be formed in the base 121.

The second body 120 may include a base 121 and a side plate 129 being extended vertically from the base 121. It includes a base 121 having a planar shape facing the first substrate 131 and a side plate 129 being extended from the base 121 in an optical axis direction. The side plate 129 of the second body 120 may comprise: a body portion 122 being extended from the edge of the base 121; a first extension portion 126 being extended from the body portion 122; and a second extension portion 124 adjacent to the first extension 126 and being extended from the body 122 and formed with a coupling hole 125. The side plate 129 of the second body 120 may include a plurality of side plates 129-1 to 129-4.

Among the plurality of side plates 129-1 to 129-4, the first side plate 129-1 may comprise: a body portion 122-1; a first extension portion 126-1 being extended from the body portion 122-1; and two second extension portions 124-1 and 124-2 being formed adjacent to both sides of the first extension portion 126-1 and extended from the body portion 122-1, and respectively formed with coupling holes 125-1 and 125-2.

The second side plate 129-2 may include: one second extension portion 124-3 being extended from the body portion 122-2 and formed with a coupling hole 125-3; and two first extension portions 126-2 and 126-3 being formed on both sides of the second extension portion 124-3. The first side plate 129-1 and the second side plate 129-2 may be adjacent to each other.

The extension lengths of the first extension portion 126 and the second extension portion 124 may be different form each other. The extension length of the first extension portion 126 may be shorter than the extension length of the second extension portion 124.

The shapes of the first extension portion 126 and the second extension portion 124 being formed on each side plate are similar, but the length, width, and size of the coupling hole 125 being formed may be different from each other.

The second extension 124 may include: a first inclined portion 201 being inclined inward from the body portion 122; a vertical portion 202 being extended perpendicularly to the body portion 122 from the first inclined portion 201; and a second inclined portion 203 being extended outward from the vertical portion 202. At least a portion of the first inclined portion 201 and the second inclined portion 203 may be curved and inclined into a round shape. A coupling hole 125 is formed in the vertical portion 202 so that it can be coupled to the protrusion 114 being formed in the first body 110.

The third side plate 129-3 facing the first side plate 129-1 may be formed to correspond to the shape of the first side plate 129-1, and the shape may be different from that of the second side plate 129-2.

The body portion 122-4 of the fourth side plate 129-4 may include a hole 171 through which the connector 170 being connected to the outside passes or a hole 181 through which the power connector 180 being connected to power source passes. The first side plate 129-1 to the third side plate 129-3 performs coupling with the first body 110, and the fourth side plate 129-4 may perform connection to the outside.

The side plate 112 of the first body 110 is formed to correspond to the side plate 129 of the second body 120 so that it can be connected to the side plate 129 of the second body 120.

The side plate 112 of the first body 110 may include: a first accommodating portion 116 in which the first extension portion 126 is accommodated at a position corresponding to the first extension portion 126, and a second accommodating portion 115 in which the second extension portion 124 is accommodated in a position corresponding to the second extension portion 124, and includes a protrusion 114 being coupled to the coupling hole 125 of the second extension portion 124.

Exemplarily, corresponding to the first extension portion 126-1 and second extension portions 124-1 and 124-2 formed on the first side plate 129-1 of the second body 120 of FIG. 10, a first accommodating portion 116-1 and second accommodating portions 115-1 and 115-2 are formed in the first side plate 112-1 of the first body 110 of FIG. 4. A rib is formed in the first accommodating portion 116-1 corresponding to the extension height of the first extension portion 126-1. The rib of the first accommodating portion 116-1 is formed toward the side plate 129 of the second body 120 to correspond to the extension height of the first extension portion 126-1 only in a portion corresponding to the extension height of the first extension portion 126-1 along the lengthwise direction of the side plate 112-1 of the first body 110. The width of the rib in the first accommodating portion 116-1 corresponds to the width of the first extension portion 126-1. In the second accommodating portions 115-1 and 115-2, ribs are formed throughout the entire region of the side plate 112-1 of the first body 110 along the longitudinal direction regardless of the extension height of the second extension portions 124-1 and 124-2. The widths of the ribs in the second accommodating portions 115-1 and 115-2 corresponds to the width of the second extension portions 124-1 and 124-2.

The widths of the first extension portion 126-1 and the second extension portions 124-1 and 124-2 respectively correspond to the widths of the ribs of the first accommodating portion 116-1 and the second accommodating portions 115-1 and 115-2, and when coupled, the rib of the first accommodating portion 116-1 and the ribs of the second accommodating portions 115-1 and 115-2 respectively guide the first extension portion 126-1 and the second extension portions 124-1 and 124-2. In addition, although not shown, the shape of the third side plate 112-3 facing the first side plate 112-1 among the plurality of side plates 112-1 to 112-4 of the first body 110 may be the same as the shape of the first side plate 112-1. It may have a first accommodating portion (not shown) and a second accommodating portion (not shown) at corresponding positions.

Similarly, corresponding to the first extension portions 126-2 and 126-3 and the second extension portion 124-3 formed on the second side plate 129-2 of the second body 120 of FIG. 10, a first accommodating portions 116-2 and 116-3 and a second accommodating portion 115-3 are formed in the second side plate 112-2 of the first body 110 of FIG. 4. Ribs are formed in the first accommodating portions 116-2 and 116-3 corresponding to the extension height of the first extension portions 126-2 and 126-3. The ribs of the first accommodating portions 116-2 and 116-3 are formed toward the side plate 129 of the second body 120 to correspond to the extension height of the first extension portions 126-2 and 126-3 only in a portion corresponding to the extension heights of the first extension portions 126-2 and 126-3 along the lengthwise direction of the side plate 112 of the first body 110. The widths of the ribs in the first accommodating portions 116-2 and 116-3 correspond to the widths of the first extension portions 126-2 and 126-3. In the second accommodating portion 115-3, ribs are formed throughout the entire region of the side plate 112 of the first body 110 along the lengthwise direction regardless of the extension height of the second extension portion 124-3. The width of the rib in the second accommodating portion 115-3 corresponds to the width of the second extension portion 124-3.

The protrusion 114 of the second accommodating portion 115 is formed to correspond to the coupling hole 125 of the second extension portion 124, and when coupled, the protrusion 114 is hooked to the coupling hole 125.

Coupling of the protrusion 114 and the coupling hole 125 prevents the first body 110 and the second body 120 from separating in opposite directions, and the coupling of the first extension portion 126 and the first accommodating portion 116 prevents the first body 110 and the second body 120 from nearing each other in a direction to be facing each other as the first extension portion 126 and the first accommodating portion 116 are come into contact with each other. That is, when the first body 110 and the second body 120 are coupled, movement in both directions of the optical axis can be prevented, and the coupling of the first body 110 and the second body 120 can be firmly maintained.

In order to increase the accuracy of depth images, the separation gap between the light source element 160 and the sensor 150 must be fixed. Because the offset of the flight distance changes when the separation gap between the light source element 160 and the sensor 150 changes, the reliability of depth images being generated from TOF sensors may be degraded. When the light source element 160 and the sensor 150 are disposed on the same substrate, there is no separation gap between the light source element 160 and the sensor 150, thereby lowering the possibility of occurring such problems, but when the light source element 160 and the sensor 150 are formed in different substrates, the separation gap between the light source element 160 and the sensor 150 may vary, therefore, maintaining the separation gap between the light source element 160 and the sensor 150 is very important.

The first region 111-1 and the second region 111-2 of the first body 110 are spaced apart from each other and are integrally formed, the first substrate 131 is connected to and fixed to the first region 111-1 of the first body 110, and the second substrate 132 is fixed by connecting the second region 111-2 of the first body 110, thereby firmly maintaining the gap between the first substrate 131 and the second substrate 132. Through this, there is an effect of maintaining the reliability of the TOF sensor even if the light source element 160 and the sensor 150 are formed in different substrates in order to dispose the light source element 160 and the sensor 150 close to each other.

Those skilled in the art related to this embodiment will understand that the description described above can be implemented in a modified form without departing from the essential characteristics. Therefore, the disclosed methods should be considered from an explanatory rather than a restrictive perspective. The scope of the present invention is indicated in the claims rather than the foregoing description, and all differences within the equivalent scope should be construed as being included in the present invention.

1. A camera module comprising:
a lens barrel accommodating a lens;
a sensor configured to receive light passed through the lens;
a first substrate having the sensor disposed on a first surface thereof;
a second substrate apart from the first substrate and having at least one light source element being disposed thereon;
a first body comprising a lens barrel accommodating portion comprising a first hole in which the lens barrel is accommodated, and a second hole formed in a light-emitting direction of the light source device; and
a second body coupled to the first body,
wherein the first substrate and the second substrate are disposed in the inner space formed by the first body and the second body.

2. The camera module according to claim 1, comprising:
a flexible substrate connecting the first substrate and the second substrate.

3. The camera module according to claim 1,
wherein the first body comprises:
an upper plate comprising a first region where the lens barrel accommodating portion formed, a second region apart from the first region in an optical axis direction and where the second hole formed, and a third region connecting the first region and the second region; and
a side plate extended from the upper plate.

4. The camera module according to claim 3,
wherein lens barrel accommodating portion is formed by being extended from the first region and the third region.

5. The camera module according to claim 3, comprising:
a recessed portion formed in the second region and the third region and corresponding to a shape of the lens barrel, in a position corresponding to the lens barrel when the lens barrel is accommodated in a lens barrel accommodating portion.

6. The camera module according to claim 5,
wherein a cross-section of the second hole is in a shape of a cube, and
wherein the second hole is inclinedly formed so that a cross-sectional region is expanded in the light-emitting direction of the light source element.

7. The camera module according to claim 3,
wherein the second body comprises:
a base; and
a side plate extended vertically from the base,
wherein the side plate of the second body comprises:
a body portion extended vertically from the base;
a first extension portion extended from the body portion; and
a second extension portion adjacent to the first extension portion and extended from the side plate of the second body, and where a coupling hole formed.

8. The camera module according to claim 7,
wherein the side plate of the first body comprises:
a first accommodating portion in which the first extension portion is accommodated at a position corresponding to the first extension portion; and
a second accommodating portion in which the second extension portion is accommodated at a position corresponding to the second extension portion, and comprising a protrusion coupled to the coupling hole of the second extension portion.

9. The camera module according to claim 7,
wherein the side plate of the second body comprises:
a first side plate comprising one first extension portion and two second extension portions formed at both sides of the one first extension portion; and
a second side plate comprising one second extension portion and two first extension portions formed at both sides of the one second extension portion.

10. The camera module according to claim 1, wherein a cross-sectional region of the second hole corresponds to a cross-sectional region of the light source element.

11. The camera module according to claim 10,
wherein cross-sectional region of the second hole is formed to be inclined so as to widen the cross-sectional region in the light-emitting direction.

12. The camera module according to claim 10,
wherein an inclined angle of the second hole corresponds to a light emitting angle of the light source element.

13. The camera module according to claim 1,
wherein the second body comprises a heat sink.

14. The camera module according to claim 1,
wherein the first body and the second body comprise a third hole through which a connector connected to an outside in a direction perpendicular to the optical axis or a power connector where power source is connected passes.

15. The camera module according to claim 1,
wherein the sensor comprises a ToF sensor.

16. The camera module according to claim 3,
wherein the first region and the second region of the upper plate form a step.

17. The camera module according to claim 6,
wherein a surface adjacent to the recessed portion among four inclined surfaces of the second hole comprises a rib formed according to a shape of the recessed portion.

18. The camera module according to claim 8,
wherein the first accommodating portion comprises a rib corresponding to an extending height of the first extension portion.

19. The camera module according to claim 18,
wherein a width of the rib of the first accommodating portion corresponds to a width of the first extension portion.

20. The camera module according to claim 8,
wherein the protrusion is hook-coupled to the coupling hole of the second extension portion.
